(19) United States
(12) Patent Application Publication
(10) Pub. No.: US 2026/0084761 A1
(43) Pub. Date: Mar. 26, 2026

(54) Spoiler assembly for a pickup truck roof fixture with movable and fixed portions

(71) Applicant: BRIDGESPORT - TRUCK ACCESSORIES CORPORATION, Toronto (CA)

(72) Inventor: Serge Moreau, Newmarket (CA)

(21) Appl. No.: 19/336,096

(22) Filed: Sep. 22, 2025

Related U.S. Application Data
(60) Provisional application No. 63/697,838, filed on Sep. 23, 2024.

(51) Int. Cl. B62D 35/00; B60Q 1/44

(52) U.S. Cl. CPC B62D 35/007; B60Q 1/44

(57) ABSTRACT

A spoiler assembly for a pickup truck having a roof supporting a fixture. The spoiler assembly includes a fixed portion mounted to the roof and a mobile portion that moves relative to the fixed portion between two positions. In one position, the mobile portion covers the fixture, and in the other, it is spaced apart therefrom.

### FIELD OF THE INVENTION

The present invention relates to automotive vehicles. More specifically, the present invention is concerned with a spoiler assembly for a pickup truck roof fixture with movable and fixed portions.

### BACKGROUND

The field relevant to the present discussion involves automotive accessories, specifically those designed for pickup trucks. Pickup trucks often face challenges when transporting elongated objects such as ladders or lumber, as these items can protrude from the vehicle's bed, posing safety and logistical concerns. Spoilers are commonly installed for aerodynamic efficiency and aesthetic enhancement; however, integrating structural utility to support long loads is not typically within their design consideration. Existing solutions inadequately address the dual need for aerodynamic function and load-bearing capacity.

Prior art, such as U.S. Pat. No. 9,346,410 B2, attempts to tackle aspects of this issue by providing a spoiler that has the required structural integrity for supporting loads. Despite its utility, this prior art does not sufficiently resolve the problem of supporting long objects without risking damage to the vehicle's structure or compromising safety. Specifically, it lacks a mechanism that allows for both permanent attachment to the vehicle and the flexibility to accommodate rear vehicle features such as brake lights and already mounted spoilers.

Accordingly, there is a need in the industry to provide an improved device for supporting loads carried by a pickup truck. An object of the present invention is therefore to provide such a device.

### SUMMARY OF THE INVENTION

In a broad aspect, there is provided a spoiler assembly for a pickup truck having a cabin, the cabin having a roof to which a fixture is mounted, the spoiler assembly comprising: a fixed portion configured to be permanently mounted to the roof, the fixed portion being elongated; and a mobile portion configured to be movable relative to the fixed portion between first and second positions, wherein in the first position, the mobile portion covers at least part of the fixture, and in the second position, the mobile portion is spaced apart from the fixture.

The spoiler assembly is designed to enhance the functionality of pickup trucks by providing a means to transport long objects without protruding from the back of the vehicle, as they abut against the cabin indirectly through the spoiler, without damaging the fixture. Typically, the spoiler assembly typically provides this functionality with minimal impact on the aerodynamics of the pickup truck while maintaining a relatively pleasant aesthetic aspect.

There may also be provided a spoiler assembly wherein the mobile portion is hinged to the fixed portion.

There may also be provided a spoiler assembly wherein the mobile portion is hinged to the fixed portion through a live hinge.

There may also be provided a spoiler assembly wherein the mobile portion abuts against the fixture in the first position.

There may also be provided a spoiler assembly wherein the mobile portion overlaps the fixture in the first position.

There may also be provided a spoiler assembly wherein the mobile portion includes a central portion for overlapping the fixture and lateral portions located laterally relative to the central portion and configured for abutting against the roof in the first position.

There may also be provided a spoiler assembly wherein the fixture is a brake light casing, and wherein the mobile portion is configured to allow access to the brake light casing in the second position for brake light maintenance. There may also be provided a spoiler assembly wherein the mobile portion extends along a hole length of the fixed portion.

There may also be provided a spoiler assembly wherein the mobile portion extends along part of a hole length of the fixed portion.

There may also be provided a spoiler assembly wherein the mobile portion is adapted to pivot and nest against the fixed portion in the second position.

There may also be provided a spoiler assembly wherein one of the mobile and fixed portions defines a recess extending thereinto and another one of the mobile and fixed portions defines a protrusion protruding therefrom, the recess and protrusion being complementarily shaped so that the protrusion is received in the recess in the second position.

There may also be provided a spoiler assembly wherein the fixture is a spoiler, and wherein the mobile portion is configured to abut against the spoiler in the first position and to be retracted from the spoiler in the second position.

There may also be provided a spoiler assembly wherein the mobile portion is configured to provide clearance for an elongated ladder carried in a bed of the pickup truck and abutting on the spoiler assembly to clear the spoiler when the mobile portion is in the second position.

There may also be provided a spoiler assembly wherein the mobile portion is secured to the fixture using a fastening mechanism.

There may also be provided a spoiler assembly wherein the fastening mechanism comprises patches of hook-and-loop fasteners.

There may also be provided a spoiler assembly further comprising a frictional element extending between the fixed and mobile portions to maintain the mobile portion in at least one of the first or second positions.

In another broad aspect, there is provided a combination comprising: a pickup truck having a cabin, the cabin having a roof to which a fixture is mounted; and a spoiler assembly, wherein the spoiler assembly comprises: a fixed portion mounted to the roof, the fixed portion being elongated; and a mobile portion configured to be movable relative to the fixed portion between first and second positions with the fixed portion remaining mounted to the roof, wherein in the first position, the mobile portion covers at least part of the fixture, and in the second position, the mobile portion is spaced apart from the fixture.

Other objects, advantages and features of the present invention will become more apparent upon reading of the following non-restrictive description of preferred embodiments thereof, given by way of example only and in relation with the following Figures.

### BRIEF DESCRIPTION OF THE DRAWINGS

FIG. 1 is a perspective view of a pickup truck comprising a spoiler assembly mounted to the cabin roof;

FIG. 2 is a perspective view of the spoiler assembly of FIG. 1 mounted to the cabin roof;

FIG. 3 is a perspective view of the spoiler assembly of FIG. 1 in a first configuration;

FIG. 4 is a perspective view of the spoiler assembly of FIG. 1 in a second configuration;

FIG. 5 is a perspective view of an alternative spoiler assembly;

FIG. 6 is a side elevation view of the spoiler assembly of FIG. 5 mounted to the cabin roof in a first configuration; and

FIG. 7 is a perspective view of the spoiler assembly of FIG. 5 in a second configuration.

### DETAILED DESCRIPTION

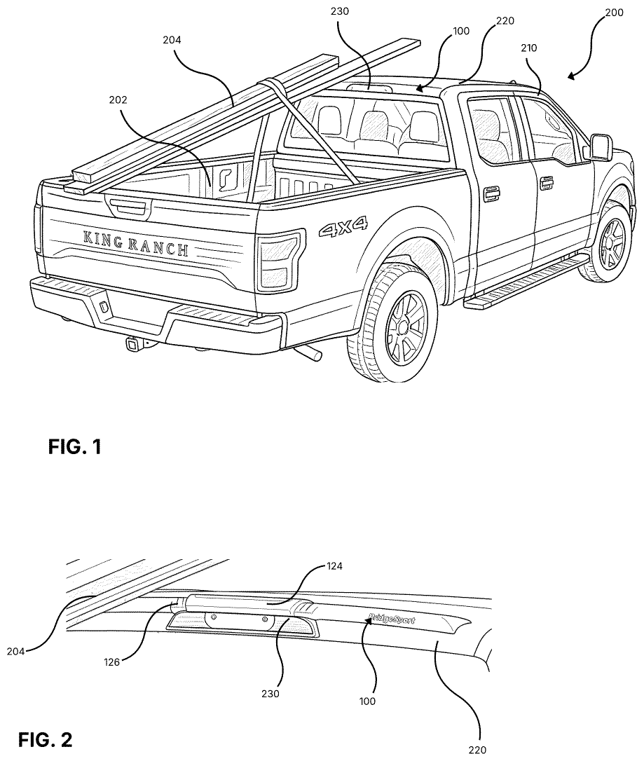

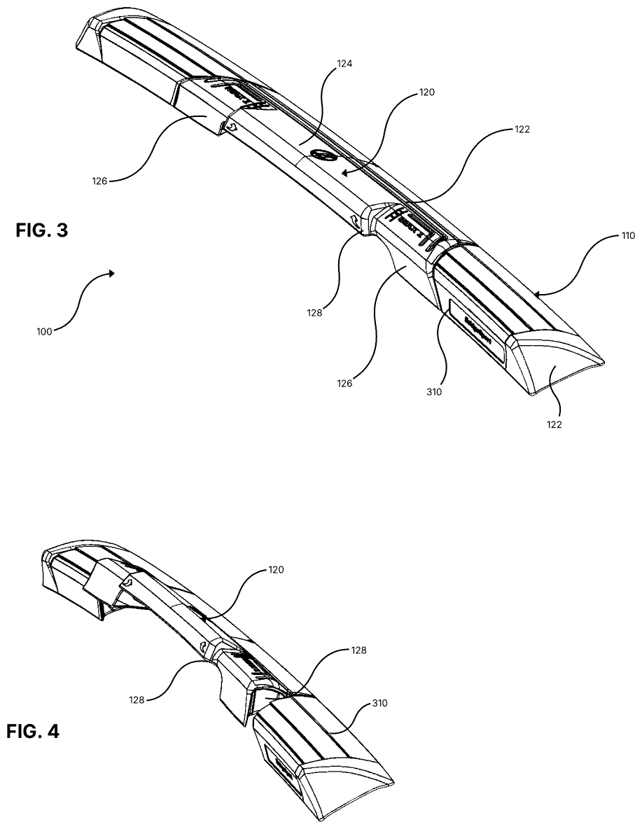

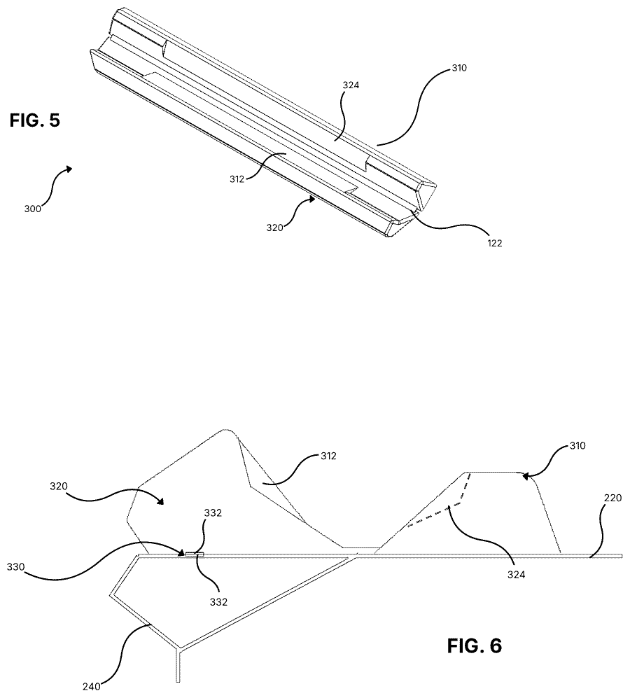

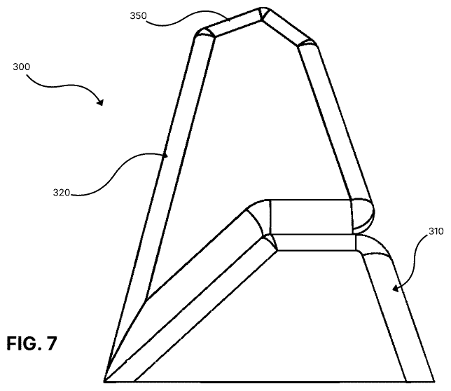

Referring collectively to FIGS. 1 and 2, there is shown a spoiler assembly 100 for a pickup truck 200. The pickup truck 200 includes a cabin 210 with a roof 220, to which a fixture 230, such as a brake light having a brake light casing, is mounted. Other examples of fixtures 240 include a spoiler, as seen for example in FIGS. 5 and 7. The fixture 230 is typically configured to be non load-bearing, or non-structural, and is too weak to support any significative load thereonto without being damaged. For example, a load carried in the bed 202 of the pickup truck 200, as exemplified by elongated wood boards 204 in FIG. 1, would typically damage the fixture 230 if abutting thereagainst while being carried. The spoiler assembly 100 is designed to assume the load-bearing functionality without requiring one to modify or remove the fixture 230, that is typically installed on the pickup truck 200 during the manufacturing process. The spoiler assembly 100 is designed to enhance the functionality of the pickup truck 200 by providing a means to transport long objects without protruding from the back of the vehicle, while also allowing access to the fixture 230 when necessary. The spoiler assembly 100 is typically designed to provide this functionality with minimal impact on the aerodynamics of the pickup truck 200 while providing a pleasant aesthetic aspect.

Referring to FIGS. 3 and 4, the spoiler assembly 100 comprises a fixed portion 110 and a mobile portion 120. The fixed portion 110 is configured to be permanently mounted to the roof 220 of the cabin 210. The fixed portion 110 is elongated and provides structural support for the spoiler assembly 100. The fixed portion 110 is typically secured to the metallic area of the truck's roof 220, which is capable of withstanding weight, as it is designed to be robust to protect the occupants of the pickup truck 200 in case of a rollover. The fixed portion 110 is typically relatively robust, so that useful loads can be applied thereto without damage. The fixed portion 110 also defines an undersurface 132 that is designed to conform to the shape of the cabin 210 to facilitate secure attachment to the latter, for example using adhesives.

The mobile portion 120 is configured to be movable relative to the fixed portion 110. The mobile portion 120 is capable of transitioning between a first position, seen for example in FIG. 3, and a second position, seen for example in FIG. 4. In the first position, the mobile portion 120 covers at least part of the fixture 230, such as the brake light casing. In the second position, the mobile portion 120 is spaced apart from the fixture 230, allowing access for maintenance or other purposes.

In one embodiment, the mobile portion 120 is hinged to the fixed portion 110 through a hinge 122, allowing it to pivot. The hinge 122 may be a live hinge, which is an integral hinge formed from the same material as the mobile portion 120 and the fixed portion 110. This live hinge is designed to provide a flexible connection that permits the mobile portion 120 to rotate relative to the fixed portion 110 without the need for additional mechanical components. The live hinge may be constructed by creating a thin section of material between the mobile portion 120 and the fixed portion 110, allowing for repeated bending and flexing while maintaining structural integrity. This configuration facilitates the transition of the mobile portion 120 between the first and second positions, as described herein. In an alternative embodiment, the connection between the fixed portion 110 and the mobile portion 120 may employ a mechanical hinge distinct from a live hinge. The mechanical hinge may include a pin-and-barrel configuration, wherein a hinge pin is inserted through aligned barrels positioned at the edges of the fixed portion 110 and the mobile portion 120. This configuration allows for the pivotal movement of the mobile portion 120 relative to the fixed portion 110 while ensuring structural robustness.

In some embodiments, the hinge 122 may incorporate a frictional element 128 to maintain the mobile portion 120 in either or both the first or second positions without auxiliary locking mechanisms. Such a frictional element may consist of a compressible material positioned between the mobile and fixed portions 120 and 110 of a thickness such that it is compressed when between the mobile and fixed portions 120 and 110. This feature provides stability to the spoiler assembly 100 during transit and allows for ease of operation without additional components. The frictional element may also be integrated to the hinge in alternative embodiments.

The mobile portion 120 extends along part of the length of the fixed portion 110 as the brake light is a relatively short component, which does not require access along the whole width of the pickup truck 200. However, in alternative embodiments, as described further below, the mobile portion 120 may extend along the entire length of the fixed portion 110. In the embodiment shown in FIGS. 1 to 4, the mobile portion 120 overlaps the fixture 230 in the first position, and protrudes laterally therefrom so that portions thereof may also be supported by the roof 220. More specifically, the mobile portion 120 includes a central portion 124, designed to be in register with the fixture 230 in the first position, and lateral portions 126 on each side of the central portion 124 that protrude downwardly towards the roof 220 and configured to abut thereagainst in the first portion. Together, the central portion 124 and lateral portions 126 define a recess 128 configured to conform generally with the shape of the fixture 230, and structured to protect the latter by supporting loads that may be applied thereto by transmitting these loads to the roof 220, instead of transmitting them to the fixture 230.

In some embodiments, the spoiler assembly 100 is designed to minimize aerodynamic drag when in the first position. The fixed portion 110 of the spoiler assembly 100 is configured to mount flush with the roof 220 of the pickup truck cabin 210 at the front section, thereby promoting streamlined airflow and reducing resistance. When mounted to the cabin 210, the front surface of the fixed portion 110 is inclined or parallel relative to the direction of travel of the pickup truck 100, further facilitating smooth airflow over the surface and minimizing any aerodynamic disruption.

In the first position, as seen in FIG. 3, the mobile portion 120 is positioned to cover and conform to at least part of the fixture 230, ensuring that the assembly does not create too much additional wind resistance. With the mobile portion 120 overlapping the fixture 230 and also being configured to abut against the roof at lateral portions 126, the spoiler assembly 100 maintains an aerodynamic profile that aligns with the existing contour of the truck cabin.

This configuration, including the flush mounting and inclined surfaces, contributes to reduced air turbulence and assists in preserving the vehicle's fuel efficiency by preventing undue drag forces when the mobile portion 120 is in the stowed first position.

FIGS. 5 to 7 illustrate a second embodiment of a spoiler assembly 300. The spoiler assembly 300 is similar to the spoiler assembly 100 in that it includes fixed and mobile portions 310 and 320 linked to each other through a hinge 322. However, the mobile portion 320 extends along the whole length of the fixed portion 310. This embodiment is useful in cases in which the fixture 240 is, for example, a spoiler, extending the whole width of the cabin 210. In such cases, the mobile portion 320 is not used to support loads, as in the previously described embodiment. Indeed, since the fixture 240 extends along the whole cabin 210, abutting the mobile portion 320 against the fixture 240 would not resolve the issue with the limited load-bearing capabilities of the fixture 240. Instead, the mobile portion 320 is designed to fold over the fixed portion 310, so as to create a raised surface above the cabin 210 against which loads can lean.

More specifically, in the first position, the mobile portion 320 abuts against the fixture 240, providing a streamlined appearance. In the second position, the mobile portion 320 is folded over the fixed portion 310, which is secured to the cabin 210 typically in front of the mobile portion 320. This creates a higher profile above the cabin 210, such that when loads are abutted against the thus folded mobile portion 320, such loads don't contact the fixture 230.

In some embodiments, the mobile portion 320 is adapted to pivot and nest against the fixed portion 310. For example, the mobile portion 320 includes a recess 324, and the fixed portion 310 includes a protrusion 312, both laterally centered with respect to the width of the cabin 210. The recess 324 and protrusion 312 are complementarily shaped, allowing the protrusion 312 to be received in the recess 324 when the mobile portion 320 is in the second position. This provides stability to the spoiler assembly 300 in the second position.

In some embodiments, the mobile portion 320 may be secured to the fixture 230 using a fastening mechanism 330. The fastening mechanism 330 may comprise patches 332 of a hook-and-loop fastener, such as 3M Dual Lock, which allows the mobile portion 320 to be easily repositioned while providing secure attachment in the first portion.

In some embodiments, the mobile portion defines an abutment surface 350 configured for abutting the load supported by the mobile portion 320 in the second position thereonto that is angled to that the load is distributed along the whole surface. For example, this angle is obtained by measuring the dimensions of the pickup truck 200 and ensuring that a long rectilinear object carried in the bed 202 abuts parallel to the abutment surface 350.

As in the spoiler assembly 100, the spoiler assembly 300 is configured to provide a generally aerodynamic profile in the first position through combination of flush mounting to the pickup truck 200 and slanted front facing surfaces.

Although the present invention has been described hereinabove by way of exemplary embodiments thereof, it will be readily appreciated that many modifications are possible in the exemplary embodiments without materially departing from the novel teachings and advantages of this invention. Accordingly, the scope of the claims should not be limited by the exemplary embodiments, but should be given the broadest interpretation consistent with the description as a whole. The present invention can thus be modified without departing from the spirit and nature of the subject invention as defined in the appended claims.

What is claimed is:

1. A spoiler assembly for a pickup truck having a cabin, the cabin having a roof to which a fixture is mounted, the spoiler assembly comprising:
a fixed portion configured to be permanently mounted to the roof, the fixed portion being elongated; and
a mobile portion configured to be movable relative to the fixed portion between first and second positions, wherein in the first position, the mobile portion covers at least part of the fixture, and in the second position, the mobile portion is spaced apart from the fixture.

2. The spoiler assembly of claim 1, wherein the mobile portion is hinged to the fixed portion.

3. The spoiler assembly of claim 2, wherein the mobile portion is hinged to the fixed portion through a live hinge.

4. The spoiler assembly of claim 1, wherein the mobile portion abuts against the fixture in the first position.

5. The spoiler assembly of claim 1, wherein the mobile portion overlaps the fixture in the first position.

6. The spoiler assembly of claim 5, wherein the mobile portion includes a central portion for overlapping the fixture and lateral portions located laterally relative to the central portion and configured for abutting against the roof in the first position.

7. The spoiler assembly of claim 5, wherein the fixture is a brake light casing, and wherein the mobile portion is configured to allow access to the brake light casing in the second position for brake light maintenance.

8. The spoiler assembly of claim 1, wherein the mobile portion extends along a hole length of the fixed portion.

9. The spoiler assembly of claim 1, wherein the mobile portion extends along part of a hole length of the fixed portion.

10. The spoiler assembly of claim 1 wherein the mobile portion is adapted to pivot and nest against the fixed portion in the second position.

11. The spoiler assembly of claim 10, wherein one of the mobile and fixed portions defines a recess extending thereinto and an other one of the mobile and fixed portions defines a protrusion protruding therefrom, the recess and protrusion being complementarily shaped so that the protrusion is received in the recess in the second position.

12. The spoiler assembly of claim 10, wherein the fixture is a spoiler, and wherein the mobile portion is configured to abut against the spoiler in the first position and to be retracted from the spoiler in the second position.

13. The spoiler assembly of claim 12, wherein the mobile portion is configured to provide clearance for an elongated ladder carried in a bed of the pickup truck and abutting on the spoiler assembly to clear the spoiler when the mobile portion is in the second position.

14. The spoiler assembly of claim 1, wherein the mobile portion is secured to the fixture using a fastening mechanism.

15. The spoiler assembly of claim 14, wherein the fastening mechanism comprises patches of hook-and-loop fasteners.

16. The spoiler assembly of claim 9, further comprising a frictional element extending between the fixed and mobile portions to maintain the mobile portion in at least one of the first or second positions.

17. A combination comprising:
a pickup truck having a cabin, the cabin having a roof to which a fixture is mounted; and
a spoiler assembly including
a fixed portion mounted to the roof, the fixed portion being elongated; and
a mobile portion configured to be movable relative to the fixed portion between first and second positions with the fixed portion remaining mounted to the roof, wherein in the first position, the mobile portion covers at least part of the fixture, and in the second position, the mobile portion is spaced apart from the fixture.
